(19) United States
(12) Patent Application Publication
(10) Pub. No.: US 2022/0324026 A1
(43) Pub. Date: Oct. 13, 2022

(54) APPARATUS AND METHODS FOR CALIBRATING ON-AXIS TEMPERATURE SENSORS FOR ADDITIVE MANUFACTURING SYSTEMS

(71) Applicant: Sigma Labs, Inc., Santa Fe, NM (US)

(72) Inventors: Darren Beckett, Corrales, NM (US); Martin S. Piltch, Los Alamos, NM (US); Lars Jacquemetton, Santa Fe, NM (US); Alberto M. Castro, Santa Fe, NM (US); Brett Diehl, Santa Fe, NM (US)

(73) Assignee: Sigma Labs, Inc., Santa Fe, NM (US)

(21) Appl. No.: 17/719,729

(22) Filed: Apr. 13, 2022

Related U.S. Application Data
(60) Provisional application No. 63/174,435, filed on Apr. 13, 2021.
(60) Provisional application No. 63/305,583, filed on Feb. 1, 2022.

(51) Int. Cl. B22F 10/31; B22F 10/368; B22F 12/41; B22F 12/90; B33Y 10/00; B33Y 30/00

(52) U.S. Cl. CPC B22F 10/31; B22F 10/368; B22F 12/41; B22F 12/90; B33Y 10/00; B33Y 30/00; B22F 2203/11

(57) ABSTRACT

This disclosure describes various methods and apparatus for calibration of temperature sensors in additive manufacturing systems. A method for calibration of temperature sensors can include selecting a first wavelength and a second wavelength spaced apart from the first wavelength; measuring an amount of energy radiated from a black body source at the first wavelength; measuring an amount of energy radiated from the black body source at the second wavelength; generating a relationship between a ratio of the amount of energy radiated at the first wavelength to the amount of energy radiated at the second wavelength; and determining, using the relationship, variations in a temperature of a build plane of an additive manufacturing system based upon a ratio of energy radiated at the first wavelength to energy radiated at the second wavelength.

### CROSS REFERENCE TO RELATED APPLICATIONS

This application claims priority to U.S. Provisional Patent Application No. 63/174,435, for “Methods of Calibrating an On-axis Temperature Sensor for an Additive Manufacturing System” filed on Apr. 13, 2021, and U.S. Provisional Patent Application No. 63/305,583, for “Thermal Calibration of Ratiometric On-axis Melt Pool Monitoring Photodetector” filed on Feb. 1, 2022, which are hereby incorporated by reference in their entirety for all purposes.

### FIELD

The described embodiments relate generally to additive manufacturing systems, and more particularly, the present embodiments relate to apparatus and methods for calibration of temperature sensors for additive manufacturing systems.

### BACKGROUND

Additive manufacturing, or the sequential assembly or construction of a part through the combination of material addition and applied energy, takes on many forms and currently exists in many specific implementations and embodiments. Additive manufacturing can be carried out by using any of a number of various processes that involve the formation of a three dimensional part of virtually any shape. The various processes have in common the sintering, curing or melting of liquid, powdered or granular raw material, layer by layer using ultraviolet light, high powered laser, or electron beam, respectively. Unfortunately, established processes for determining a quality of a resulting part manufactured in this way are limited. Conventional quality assurance testing generally involves post-process measurements of mechanical, geometrical, or metallurgical properties of the part, which frequently results in destruction of the part. While destructive testing is an accepted way of validating a part's quality, as it allows for close scrutiny of various internal features of the part, such tests cannot for obvious reasons be applied to a production part. Consequently, ways of non-destructively and accurately verifying the mechanical, geometrical and metallurgical properties of a production part produced by additive manufacturing are desired.

### SUMMARY

In some embodiments, a method of calibration in an additive manufacturing system is disclosed. The method includes measuring an amount of energy radiated from a blackbody source at a first wavelength, measuring an amount of energy radiated from the black body source at a second wavelength, the second wavelength being spaced apart from the first wavelength, and generating a relationship between a ratio of the amount of energy radiated at the first wavelength to the amount of energy radiated at the second wavelength.

In some embodiments, the measuring an amount of energy radiated from the black body source at the first wavelength is performed by a first photo detector, and the measuring an amount of energy radiated from the black body source at the second wavelength is performed by a second photo detector.

In some embodiments, the measuring an amount of energy radiated from the black body source at the first wavelength includes collecting first voltages generated by the first photo detector in response to receiving the radiated energy from the black body source.

In some embodiments, the measuring an amount of energy radiated from the black body source at the second wavelength includes collecting second voltages generated by the second photo detector in response to receiving the radiated energy from the black body source.

In some embodiments, the generating the relationship includes generating a ratio of first voltages to second voltages.

In some embodiments, the black body source is positioned where a melt pool on a build plane of an additive manufacturing system would be during an operation of the additive manufacturing system.

In some embodiments, the black body source includes a halogen lamp.

In some embodiments, the method of calibration in the additive manufacturing system further includes determining, using the relationship, variations in a temperature of a build plane of the additive manufacturing system based upon a ratio of energy radiated at the first wavelength to energy radiated at the second wavelength.

In some embodiments, the method of calibration in the additive manufacturing system further includes determining a temperature of a melt pool on a build plane of the additive manufacturing system by measuring amounts of energy radiated by the melt pool at the first and second wavelengths, and using the ratio of the first voltages to the second voltages to determine the temperature of melt pool.

In some embodiments, a calibration apparatus is disclosed. The calibration apparatus includes first and second optical sensors arranged to record an intensity of radiation emitted from a build region of an additive manufacturing system at a first bandwidth and a second bandwidth, respectively, a black body source, a processor, and a memory coupled to the processor and including instructions executable by the processor, the instructions directing the processor to: collect measured amount of energy, by the first optical sensor, radiated from the black body source at the first bandwidth, collect measured amount of energy, by the second optical sensor, radiated from the black body source at the second bandwidth, and generate a calibration relationship based on a ratio of the collected measured amount of energy radiated at the first bandwidth to the collected measured amount of energy radiated at the second bandwidth.

In some embodiments, the first and second optical sensors are first and second photo detectors, respectively.

In some embodiments, generating the calibration relationship includes generating a ratio of first generated voltages by the first photo detector for known black body source temperatures to second generated voltages by the second photo detector for known black body source temperatures.

In some embodiments, the black body source is positioned where the build region on a build plane of the additive manufacturing system would be during an operation of the additive manufacturing system.

In some embodiments, the black body source includes a tungsten strip lamp.

In some embodiments, the instructions direct the processor further to determine variations in a temperature of a build plane of the additive manufacturing system based upon a ratio of an amount of energy radiated at the first bandwidth to an amount of energy radiated at the second bandwidth.

In some embodiments, the instructions direct the processor further to determine a temperature of the build region of the additive manufacturing system based on a ratio of an amount of energy radiated by the build region at the first bandwidth to an amount of energy radiated at the second bandwidth during an operation of the additive manufacturing system by using the calibration relationship.

In some embodiments, a method of calibration is disclosed. The method of calibration includes generating first voltages, by a first photo detector, in response to receiving an amount of energy radiated from a blackbody source at a first wavelength, the black body source being at a known temperature, generating second voltages, by a second photo detector, in response to receiving an amount of energy radiated from a black body source at a second wavelength, the black body source being at the known temperature, and generating a calibration relationship based on a ratio of the first voltages to the second voltages.

In some embodiments, the method of calibration further includes determining, using the calibration relationship, variations in a temperature of a build plane of an additive manufacturing system based upon a ratio of energy radiated at the first wavelength to energy radiated at the second wavelength.

In some embodiments, the black body source includes a halogen lamp.

In some embodiments, the black body source is positioned where a molten region on a build plane of an additive manufacturing system would be during an operation of the additive manufacturing system.

### BRIEF DESCRIPTION OF THE DRAWINGS

FIG. 1 illustrates an example additive manufacturing system that is equipped with multiple optical sensors, and illustrates a blackbody source used for calibrating the optical sensors, according to an embodiment of the disclosure;

FIG. 2 illustrates an example calibration chart for a blackbody source that can be used to calibrate the additive manufacturing system shown in FIG. 1;

FIG. 3 illustrates example black body calibration spectra that can be generated by the black body source shown in FIG. 1;

FIG. 4 illustrates an example calibration relationship that can be used to identify a temperature of a melt pool using readings taken from the two optical sensors of the additive manufacturing system shown in FIG. 1;

FIG. 5A illustrates an example graph showing sensor readings taken by a spectrometer during an additive manufacturing operation, according to embodiments of the disclosure;

FIG. 5B illustrates an exemplary graph depicting at least a portion of sensor readings taken by the spectrometer employed in FIG. 5A after placing a band pass filter on the spectrometer;

FIG. 6 illustrates temperature data for a layer of a build plane, according to embodiments of the disclosure;

FIG. 7 shows an example embodiment of an additive manufacturing apparatus that can employ one or more calibrated sensors according to an embodiment of the disclosure;

FIG. 8 shows an image of the calibration setup shown in FIG. 7, according to an embodiment of the disclosure;

FIG. 9 shows a graph illustaring sensor voltage signal as a function time after a calibration lamp is powered on of the calibration set up of FIG. 7, according to an embodiment of the disclosure;

FIG. 10 shows setpoint temperature versus mean signal ratio with curve fit for the sensors shown in FIG. 7, according to an embodiment of the disclosure;

FIG. 11 shows setpoint temperature versus mean signal ratio with curve fit with a neutral density filter in the system shown in FIG. 7, according to an embodiment of the disclosure;

FIG. 12 shows a scatterplot of temperature values for a full build plate build, according to an embodiment of the disclosure; and

FIG. 13 shows a scatterplot of calibrated temperature values for a full build plate build, according to an embodiment of the disclosure.

### DETAILED DESCRIPTION

In this disclosure, apparatuses and methods for calibrating process monitors for additive manufacturing systems are described. More particularly, apparatuses and methods for calibrating on-axis temperature sensors for additive manufacturing systems are described. In some embodiments, the present disclosure describes photodiodes that may be used in an additive manufacturing system. In various embodiments, the additive manufacturing system can be arranged to collect radiation spectra from a molten region of a powder bed via a pair of on-axis photodiodes that each monitor different bandwidths. To calibrate the sensor readings with actual temperatures, a blackbody calibration source (e.g., halogen lamp) can be placed where the molten region of the powder bed would be and voltages from each of the photodiodes can be collected for known temperatures of the black body source.

A ratio of the voltages of the photodiodes can be correlated with the known temperatures of the black body to create a calibration relationship for the system. Thus, during operation, the ratio of the voltages of the photodiodes can be collected real-time and employed with the calibration relationship to derive the actual temperature of the molten region. Knowledge of the actual temperature of the molten region can be used to detect when the melt pool is too cool or too hot which may create defects in the part, as described in more detail below.

Embodiments of the present disclosure can enable thermal calibration of ratiometric on-axis melt pool monitoring photodetector system using a tungsten strip lamp. While the present disclosure can be useful for a wide variety of configurations, some embodiments of the disclosure are particularly useful for calibrating in-process quality assurance systems, as described in more detail below.

Some embodiments disclose a method for using a calibrated tungsten ribbon lamp as a reference standard to calibrate a photodetector based on-axis melt pool monitoring system for the additive manufacturing system. Calibration methods disclosed herein can enable reference to physical temperature values based on measured photodetector signals. In various embodiments, a method for use of a regression-based model based on Bichromatic Planck thermometry theory is disclosed. In some embodiments, a calibrated tungsten lamp can be placed within an additive manufacturing system and the resulting photodetector signals measured at different lamp temperature set points can be used to calibrate the regression-based model.

In some embodiments, several additional characterization test results are disclosed relating to temporal response of the tungsten lamp, spatial characteristics, measurement noise as a function of sampling time and spectroscopic measurements of the additive manufacturing optics and their potential effect on temperature calibration to improve the accuracy of the measured temperature. In various embodiments, a method is disclosed to normalize temperature readings across the build plate to remove location-dependent optical artifacts which increases the accuracy of the measured temperature. Various inventive embodiments are described herein, including methods, processes, systems, devices, and the like.

Several illustrative embodiments will now be described with respect to the accompanying drawings, which form a part hereof. The ensuing description provides embodiment(s) only and is not intended to limit the scope, applicability, or configuration of the disclosure. Rather, the ensuing description of the embodiment(s) will provide those skilled in the art with an enabling description for implementing one or more embodiments. It is understood that various changes may be made in the function and arrangement of elements without departing from the spirit and scope of this disclosure. In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

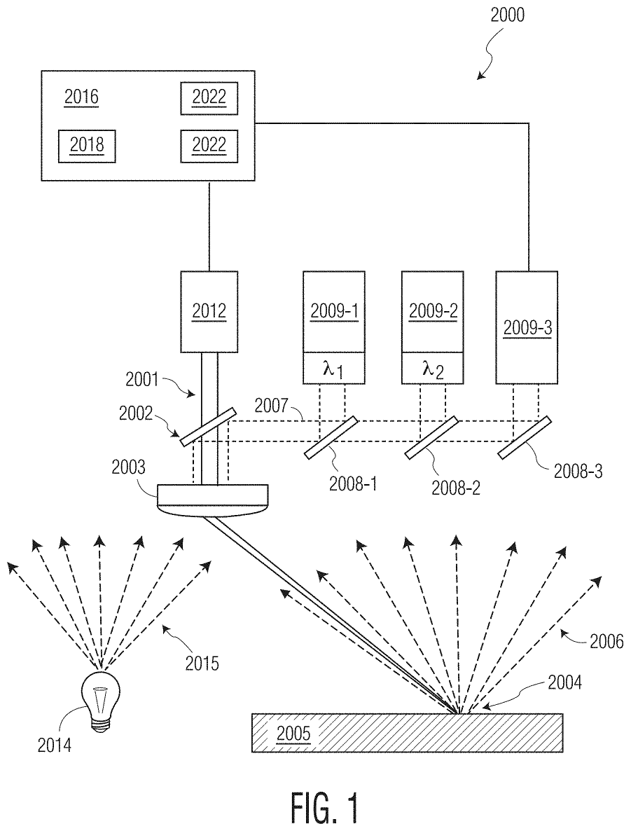

FIG. 1 shows an example additive manufacturing system that can be equipped with multiple optical sensors according to an embodiment of the disclosure. In the illustrated embodiment, a blackbody source used for calibrating the optical sensors is also shown. The additive manufacturing system can be equipped with three optical sensors in which two of the optical sensors monitor discrete wavelengths of radiation to characterize temperature variations in real-time occurring on a build plane and the third optical sensor is configured to measure thermal energy density. The thermal energy density is sensitive to changes in process parameters such as, for example, energy source power, energy source speed, and hatch spacing. The additive manufacturing system of FIG. 1 can use a laser 2012 as the energy source. The laser 2012 can emit a laser beam 2001 which passes through a partially reflective mirror 2002 and enters a scanning and focusing system 2003 which then projects the beam to a region 2004 on build plane 2005. In some embodiments, build plane 2005 can be a powder bed. Optical energy 2006 may be emitted from region 2004 on account of high material temperatures and emissivity properties of the materials receiving being irradiated by laser beam 2001.

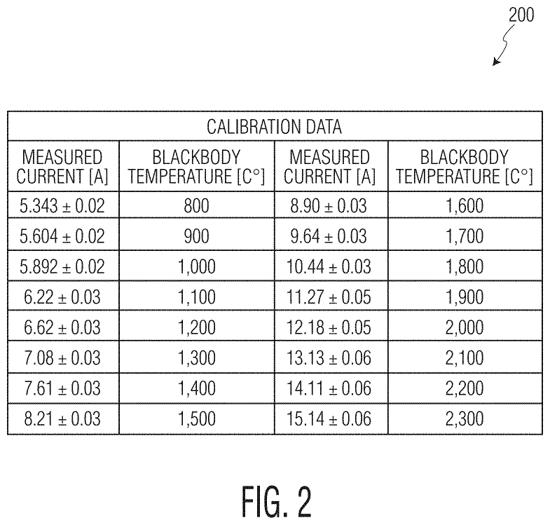

In the illustrated embodiment, a black body source 2014 can be used for calibrating the on-axis optical sensors 2009. The blackbody source 2014 can emit characteristic radiation for a given temperature to facilitate calibration of the on-axis optical sensors 2009. For example, a representative calibration chart 200 for black body source 2014 is shown in FIG. 2. For a given measured current, black body source 2014 can emit characteristic radiation for a known blackbody temperature.

In some embodiments, the scanning and focusing system 2003 can be configured to collect some of the optical energy 2006 emitted from region 2004. In some embodiments, a melt pool and luminous plume can cooperatively emit blackbody radiation from within region 2004. The melt pool is the result of powdered metal liquefying due to the energy imparted by laser beam 2001 and is responsible for the emission of a majority of the optical energy 2006 being reflected back toward focusing system 2003. The luminous plume results from vaporization of portions of the powdered metal. The partially reflective mirror 2002 can reflect a majority of optical energy 2006 received by focusing system 2003. This reflected energy is indicated on FIG. 1 as optical energy 2007. The optical energy 2007 may be interrogated by on-axis optical sensors 2009-1 and 2009-2. Each of the on-axis optical sensors 2009 receive a portion of optical energy 2007 through mirrors 2008-1 and 2008-2. In some embodiments, mirrors 2008 can be configured to reflect only wavelengths λ₁ and λ₂, respectively. In some embodiments, optical sensors 2009-1 and 2009-2 receive a total of 80-90% of the light reflected through the optics train. Optical sensors 2009-1 and 2009-2 can also include notch filters that are configured to block any light outside of respective wavelengths λ₁ and λ₂. Third optical sensor 2009-3 can be configured to receive light from partially reflective mirror 2002. As depicted, an additional mounting point could be included that allows for installation of third optical sensor 2009-3. In some embodiments, optical sensors 2009-1 and 2009-2 can be covered by notch filters while third optical sensor 2009-3 can be configured to measure a much larger range of wavelengths. In some embodiments, optical sensor 2009-1 or 2009-2 can be replaced with a spectrometer configured to perform an initial characterization of a blackbody radiation curve associated with a batch of powder being used to perform an additive manufacturing process. This characterization can then be used to determine how the wavelength filters of optical sensors 2009-1 and 2009-2 are configured to be offset and avoid any spectral peaks associated with the black body curve characterized by the spectrometer. This characterization is performed prior to a full additive manufacturing operation being carried out.

In some embodiments, scanning and focusing system 2003 can be configured to collect some of the optical energy 2015 emitted from the black body source 2014 (e.g., the melt pool region in the additive manufacturing system). More specifically, a melt pool and luminous plume can cooperatively emit blackbody radiation that is similar to the black body radiation emitted from black body source 2014. The melt pool is the result of powdered metal liquefying due to the energy imparted by laser beam 2001 and is responsible for the emission of a majority of the optical energy 2006 being reflected back toward focusing system 2003. The luminous plume results from vaporization of portions of the powdered metal.

It should be noted that the collected optical energy 2007 may not have the same spectral content as the optical energy 2006 emitted from the beam interaction region 2004 because the optical energy 2007 has suffered some attenuation after going through multiple optical elements such as partially reflective mirror 2002, scanning and focusing system 2003, and one or more of partially reflective mirrors 2008. These optical elements may each have their own transmission and absorption characteristics resulting in varying amounts of attenuation that thus limit certain portions of the spectrum of energy radiated from the beam interaction region 2004. The data generated by on-axis optical sensors 2009 may correspond to an amount of energy imparted on the work platform. This allows the notch feature wavelengths to be selected to avoid frequencies that are overly attenuated by absorption characteristics of the optical elements.

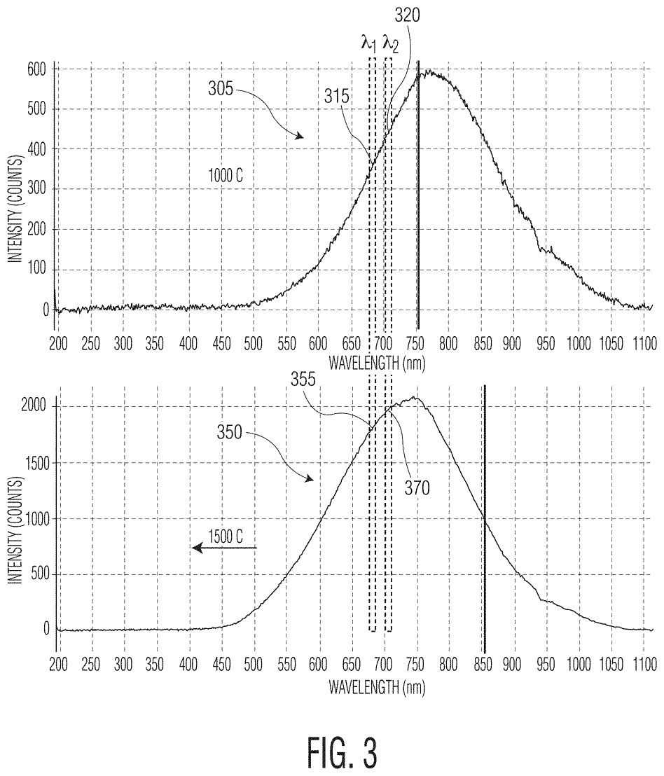

Calibration can be performed by causing black body source 2014 to emit a black body characteristic spectra for known temperatures while recording readings from on-axis optical sensors 2009. For example, FIG. 3 illustrates a first black body spectra 305 for a black body temperature of 1000 C. First optical sensor 2009-1 (see FIG. 1) is arranged to respond to an intensity of first spectra 305 at a first bandwidth λ₁ (315) of 680 nanometers+−5 nanometers. Second optical sensor 2009-2 (see FIG. 1) is arranged to respond to an intensity of first spectra 305 at a second bandwidth λ₂ (320) of 700 nanometers+−5 nanometers.

FIG. 3 also illustrates a second black body spectra 350 for a blackbody temperature of 1500 C. First optical sensor 2009-1 (see FIG. 1) is arranged to respond to an intensity of second spectra 350 at a first bandwidth λ₁ (355) of 680 nanometers+−5 nanometers. Second optical sensor 2009-2 (see FIG. 1) is arranged to respond to an intensity of second spectra 350 at a second bandwidth λ₂ (370) of 700 nanometers+−5 nanometers. In some embodiments a first bandwidth λ₁ (355) is selected relatively close to second bandwidth λ₂ (370) to reduce the effects of changes in emissivity. One of skill in the art having the benefit of this disclosure will appreciate that other bandwidths and/or temperatures can be used.

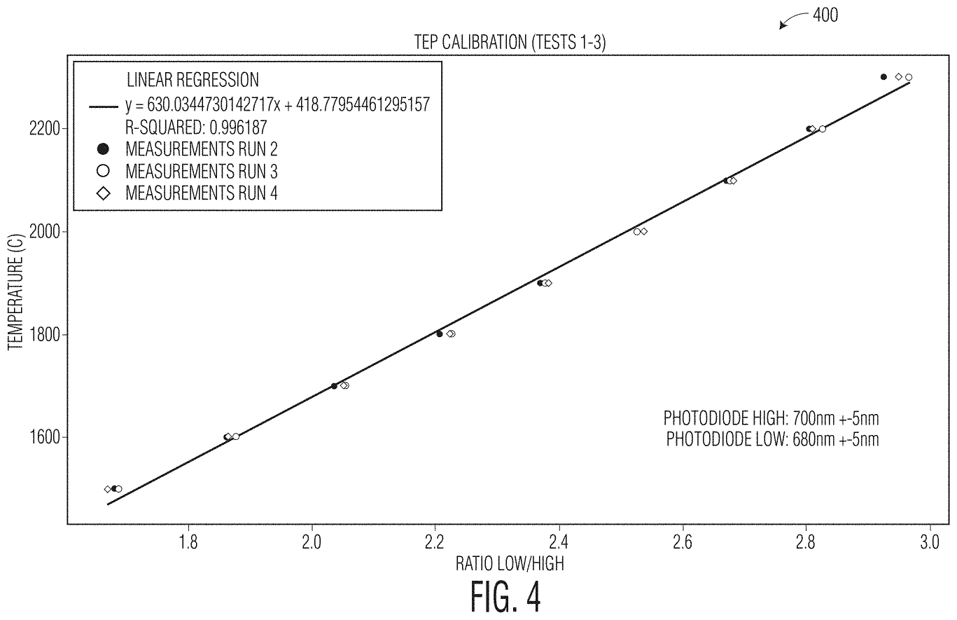

As shown in FIG. 3, as the temperature of black body source 2014 (see FIG. 1) is increased, the characteristic radiation curve shifts to the left and thus the ratio of the intensity at λ₁(315) to the intensity at λ₂ (320) changes. As shown in FIG. 4, this ratio can be plotted with respect to the known black body calibration temperatures to generate a calibration relationship 400 for the additive manufacturing system. More specifically, in some embodiments each optical sensor 2009 can generate a voltage corresponding to the received intensity at the sensor's particular bandwidth. A ratio of these voltages can be plotted against the known black body calibration temperatures (see e.g., FIG. 2). Computer 2016 (see FIG. 1) can use calibration relationship 400 to report actual temperatures of the melt pool during additive manufacturing operations. The actual temperatures can be used to quantify and identify out of specification conditions that may result in defects in the part.

Examples of on-axis optical sensors 2009 include but are not limited to photo to electrical signal transducers (i.e. photodetectors) such as pyrometers and photodiodes. The optical sensors can also include spectrometers, and low or high speed cameras that operate in the visible, ultraviolet, or the infrared frequency spectrum. The on-axis optical sensors 2009 are in a frame of reference which moves with the beam, i.e., they see all regions that are touched by the laser beam and are able to collect optical energy 2007 from all regions of the build plane 2005 touched as the laser beam 2001 scans across build plane 2005. Because the optical energy 2006 collected by the scanning and focusing system 2003 travels a path that is near parallel to the laser beam, sensors 2009 can be considered on-axis sensors.

In some embodiments, the additive manufacturing system can include off-axis sensors that are in a stationary frame of reference with respect to the laser beam 2001. Additionally, there could be contact sensors on a recoater arm configured to spread metallic powders across build plane 2005. These sensors could be accelerometers, vibration sensors, etc. Lastly, there could be other types of sensors such as thermocouples to measure macro thermal fields or could include acoustic emission sensors which could detect cracking and other metallurgical phenomena occurring in the deposit as it is being built.

In some embodiments, a computer 2016, including a processor 2018, computer readable medium 2020, and an I/O interface 2022, is provided and coupled to suitable system components of the additive manufacturing system in order to collect data from the various sensors. Data received by the computer 2016 can include in-process raw sensor data and/or reduced order sensor data. The processor 2018 can use in-process raw sensor data and/or reduced order sensor data to determine laser 2000 power and control information, including coordinates in relation to the build plane 2005. In other embodiments, the computer 2016, including the processor 2018, computer readable medium 2020, and an I/O interface 2022, can provide for control of the various system components. The computer 2016 can send, receive, and monitor control information associated with the laser 2000, the build plane 2005, and other associated components and sensors.

The processor 2018 can be used to perform calculations using the data collected by the various sensors to generate in-process quality metrics. In some embodiments, data generated by on-axis optical sensors 2009 can be used to determine thermal energy density during the build process. Control information associated with movement of the energy source across the build plane can be received by the processor. The processor can then use the control information to correlate data from on-axis optical sensor(s) 2009 and/or off-axis optical sensor(s) with a corresponding location. This correlated data can then be combined to calculate thermal energy density. In some embodiments, the thermal energy density and/or other metrics can be used by processor 2018 to generate control signals for process parameters, for example, laser power, laser speed, hatch spacing, and other process parameters in response to the thermal energy density or other metrics falling outside of desired ranges. In this way, a problem that might otherwise ruin a production part can be ameliorated. In embodiments where multiple parts are being generated at once, prompt corrections to the process parameters in response to metrics falling outside desired ranges can prevent adjacent parts from receiving too much or too little energy from the energy source.

In some embodiments, the I/O interface 2022 can be configured to transmit data collected to a remote location. The I/O interface 2022 can be configured to receive data from a remote location. The data received can include baseline datasets, historical data, post-process inspection data, and classifier data. The remote computing system can calculate in-process quality metrics using the data transmitted by the additive manufacturing system. The remote computing system can transmit information to the I/O interface 122 in response to particular in-process quality metrics. It should be noted that the sensors described in conjunction with FIG. 1 can be used in the described ways to characterize performance of any additive manufacturing process involving sequential material build up. It will be apparent to one of ordinary skill in the art that many modifications and variations are possible in view of the above teachings.

While the embodiments described herein have used data generated by optical sensors to determine the thermal energy density, the embodiments described herein may be implemented using data generated by sensors that measure other manifestations of in-process physical variables. Sensors that measure manifestations of in-process physical variables include, for example, force and vibration sensors, contact thermal sensors, non-contact thermal sensors, ultrasonic sensors, and eddy current sensors. It will be apparent to one of ordinary skill in the art that many modifications and variations are possible in view of the above teachings.

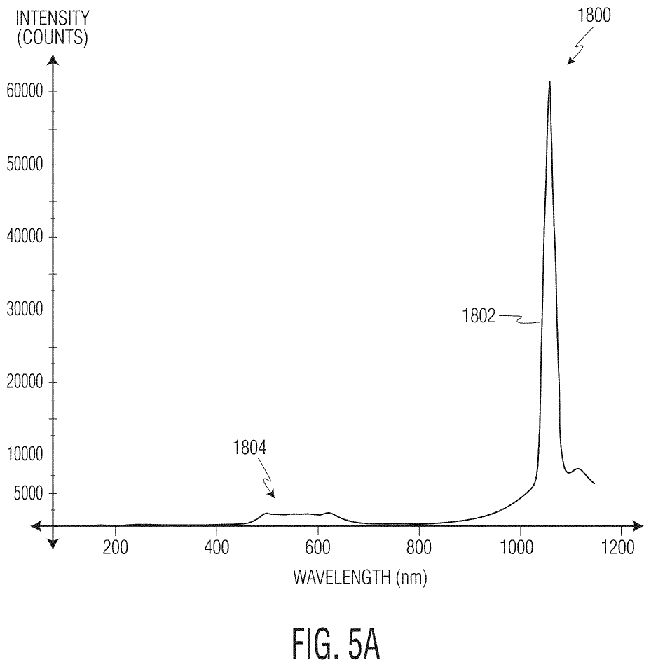

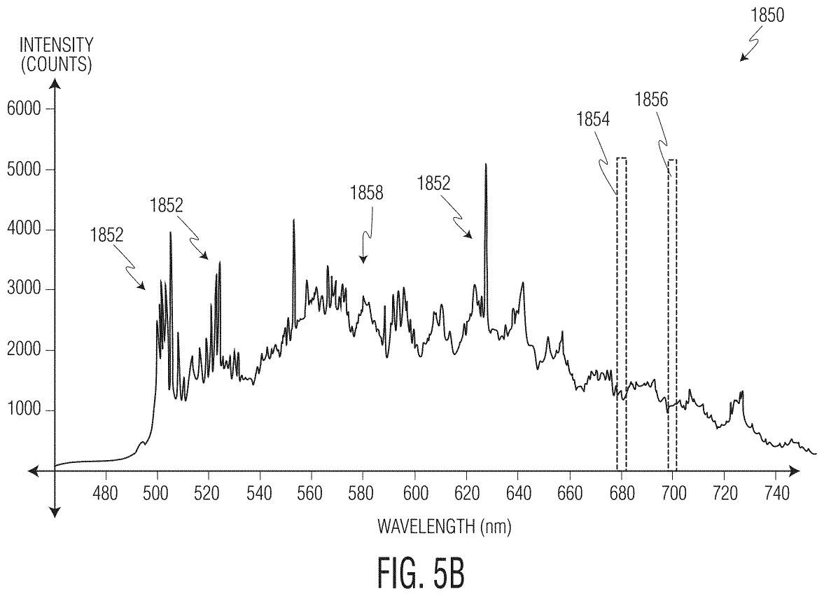

FIG. 5A shows an example graph 1800 illustrating sensor readings taken by a spectrometer during a laser-sintering additive manufacturing process using a powdered aluminum alloy. In some embodiments, the spectrometer can have a range of between 0 and 1500 nm covering both the visible and near infrared spectra. A peak 1802 centered around 1064 nm corresponds to a wavelength of an ytterbium doped laser that acts as the energy source for the additive manufacturing process. Even when baffles are installed on the laser, the magnitude of peak 1802 can be artificially increased due to light from the laser being reflected off of other surfaces in a build chamber prior to being sensed by the spectrometer. Due to the magnitude of peak 1802 the spectrometer becomes saturated with light from this wavelength, resulting in other frequencies of light that could otherwise be captured by the spectrometer being suppressed or in some cases completely obscured. For example, while peak 1804 might correspond to a blackbody radiation curve, the amplitude of the signal is too low due for feature extraction due to the saturation of the spectrometer by the laser light.

FIG. 5B shows exemplary graph 1850 which depicts a portion of sensor readings taken by the spectrometer corresponding to the previously indicated peak 1804 after adding a band pass filter to the spectrometer, which blocks out frequencies surrounding peak 1802. For example, the band pass filter could be configured to remove frequencies of light having frequencies of between 1000 and 1100 nm. Removing these frequencies from the spectrometer results in graph 1850 following the general shape of a blackbody radiation curve with the exception of certain spectral feature peaks 1852. Spectral peaks 1852 result from material properties of the powder undergoing laser irradiation. In some embodiments, these spectral peaks could occur due to the presence of neutral atoms making up the powder, ionized powder as well as electrons from the ionization. These spectral peaks 1852 generally remain at fixed wavelengths. This allows wavelengths 1854 and 1856 to be selected at frequencies offset from spectral peaks 1852. While a size of spectral peaks 1852 may vary with temperature the range of wavelengths they cover stays substantially the same over a large range of temperatures. In some embodiments, it may also be desirable to establish a trendline following the shape of a black body curve and select wavelengths that are consistently positioned upon the trend line defining the black body curve. This further helps prevent the placement of one of the selected wavelengths 1854 or 1856 upon a spectral feature that could negatively affect the accuracy of temperature data derived from sensors monitoring wavelengths 1854 and 1856.

Optical sensors monitoring wavelengths 1854 and 1856 can be configured to monitor a relatively narrow bandwidth between 0.5 nm and about 10 nm that are centered about selected wavelengths. A size of the bandwidths can depend upon the application and characteristics of the powder and energy source being used. In some embodiments, two different optical sensors can be used to collect light emitted at wavelengths 1854 and 1856. The optical sensors can take the form of photodetectors or more specifically photodiodes with dielectric multi-layer wavelength notch filters that limit the light reaching the photodiode to narrow ranges of wavelengths centered about wavelengths 1854 and 1856, respectively. While wavelengths 1854 and 1856 are positioned upon one side of the black body curve, it should be noted that the wavelengths can also be positioned on the opposite sides of the curve as long as the wavelengths do not overlap.

A ratio of the intensity of light at wavelength 1854 to the intensity of light at wavelength 1856 can be used to characterize changes or variations in temperature on the build plane. These measurements are driven by thermal radiation from the melt pool and a luminous plume proximate the melt pool that is caused by vaporization of small portions of the metal powder. A majority of the measurements come from the luminous plume as the luminous plume tends to mask the black body emissions from the melt pool. This configuration which monitors a very small range of light emitted from the build plane prevents a majority of the inaccuracies caused by broad spectrum monitoring. For example, this method of monitoring greatly reduces inaccuracies caused by laser light reflecting off the walls of an additive manufacturing apparatus. It should be noted that the blackbody radiation curve can vary substantially in wavelength depending upon the type of powdered metal being used. For example, while the graphs in FIGS. 5A and 5B correspond to aluminum, which has a blackbody radiation curve that extends between 400 nm and 900 nm, a blackbody radiation curve for titanium can be located between about 1400 and 1700 nm. For this reason, wavelengths 1854 and 1856 may be reselected when there are changes in metal powder alloy. Reselection of wavelengths 1854 and 1856 could also be desirable when desired operating temperatures are changed. An operator could change operating temperatures for a part with the same type of metal alloy when a different material grain structure is desired.

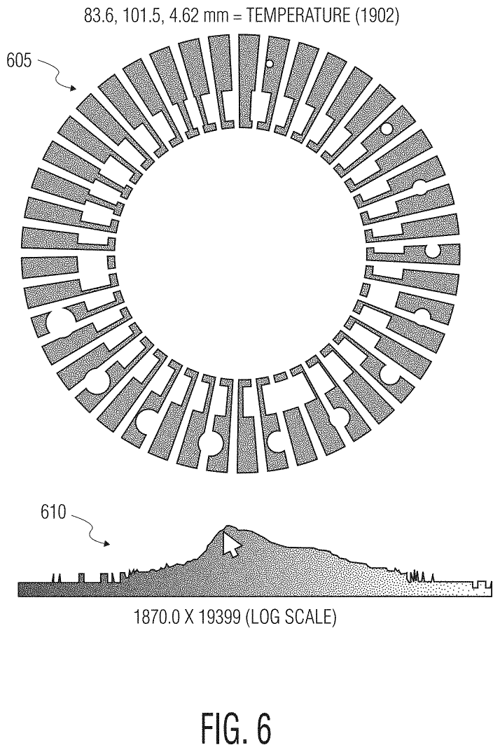

FIG. 6 illustrates example data generated for a build layer 605 of a part. More specifically, each pixel of build layer 605 represents a temperature recorded for the melt pool in that geometric location. Scale 610 illustrates the range of temperatures across build layer 605. In some embodiments an upper bound and/or a lower bound can be established for the temperatures and regions on build layer 605 can be identified as out of bounds, and thus possibly defective.

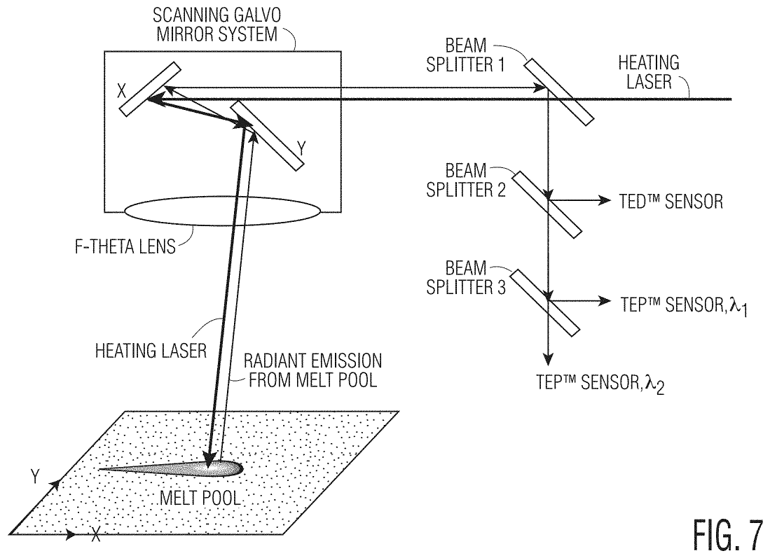

FIG. 7 shows an example embodiment of an additive manufacturing apparatus that can employ one or more calibrated sensors according to an embodiment of the disclosure. The additive manufacturing apparatus of FIG. 7 can include two on-axis single point photodetectors, each one behind a band pass filter with transmission chrematistics of λ₂ and λ₁. In some embodiments λ₁ and λ₂ are two visible light wavelengths that are similar in wavelength to each other (<50 nm difference between the two, λ₁<λ₂). Light emitted from a melt pool with these wavelengths may not be due to electron transition but due to thermal radiation. The signals from these sensors can be used to calculate a temperature value using Bichromatic Planck thermometry (e.g., ratio, dual-band or two-color pyrometry), which forms the basis of a process monitoring data metric called Thermal Emissions Planck (TEP), described in more detail herein. In one embodiment the photodetectors' analog outputs can be digitally sampled 200 kHz and stored as 32-bit floating point values. An additional photodetector can be sampled to derive another metric called Thermal Energy Density (TED).

Embodiments of the disclosure provide spatial calibration methods to normalize melt pool signals to temperature because a path length of melt pool-emitted light into the coaxial photodetectors may vary with position and variations may exist between different machines. In some embodiments, a Pyrometry LLC S6-100 calibration lamp can be used to calibrate the additive manufacturing apparatus of FIG. 7 using the principles of Bichromatic Planck thermometry.

Planck's law indicates that the wavelength-dependent radiance of a blackbody source as a function of temperature can be given by Equation 1.

$$I ( λ , T ) = \frac{2 {hc}^{2} ε}{{λ}^{5}} \frac{1}{{e}^{\frac{hc}{λ {k}_{B} T}} - 1} \qquad ( 1 )$$

Where his Planck's constant, c is the speed of light, ε is the emissivity of the source, and k_{B} is Boltzmann's constant, resulting in units of I(λ, T) as W·sr⁻¹·m⁻³. The ratio of emitted intensity at two different wavelengths at the same temperature can be calculated by Equation 2. Note that the emissivity value cancels itself out, so long as the emissivity of the melt pool at each wavelength is the same. Here, nearby wavelengths can be selected to minimize the emissivity difference.

$$\frac{I ( {λ}_{2} , T )}{I ( {λ}_{1} , T )} = {( \frac{{λ}_{1}}{{λ}_{2}} )}^{5} \frac{{e}^{\frac{hc}{{λ}_{1} {k}_{B} T}} - 1}{{e}^{\frac{hc}{{λ}_{2} {k}_{B} T}} - 1} \qquad ( 2 )$$

With typical processing values (T=1,900 OC, λ˜×500 nm), the exponential term is considerably larger than 1,

$${e}^{\frac{hc}{λ {k}_{B} T}} \sim {e}^{7} ≫ 1 ,$$

and the equation can be reduced to Equation 3.

$$\frac{I ( {λ}_{2} , T )}{I ( {λ}_{1} , T )} = {( \frac{{λ}_{1}}{{λ}_{2}} )}^{5} \frac{{e}^{\frac{hc}{{λ}_{1} {k}_{B} T}}}{{e}^{\frac{hc}{{λ}_{2} {k}_{B} T}}} \qquad ( 3 )$$

Rearranging this to calculate temperature given the two wavelengths and recorded intensities yields Equation 4.

$$T = \frac{hc ( {λ}_{2} - {λ}_{1} )}{{λ}_{2} {λ}_{1} ln ( \frac{I ( {λ}_{2} , T )}{I ( {λ}_{1} , T )} * {( \frac{{λ}_{2}}{{λ}_{1}} )}^{5} )} \qquad ( 4 )$$

The physical constants can be factored out to produce a function with two degrees of freedom, which can be calibrated to predict temperature given a ratio of sensor signals, Equation 5.

$$T = \frac{A}{ln ( B / \frac{I ( {λ}_{1} , T )}{I ( {λ}_{2} , T )} )} \qquad ( 5 )$$

While the equations describe the radiance/exitance of the source (I(λ, T)), it also holds for the signal, S, measured by two similar photodetectors occupying the same optical path. For linear photodetectors, filtered to relatively narrow wavebands (Δλ<<λ₀), the measured signal is proportional to the source emittance: S₀(T)∝I(λ₀, T). In Equation 6, the constant of proportionality is either cancelled or absorbed by the regression variable B.

$$T = \frac{A}{ln ( B / \frac{{S}_{1} ( T )}{{S}_{2} ( T )} )} \qquad ( 6 )$$

Thus, the measured signal ratio R(T)=S₁(T)/S₂(T) In some embodiments, if T is known from a calibrated radiance source set to a specific setpoint Tᵢ, then a regression model can be made: Tᵢ=f(Rᵢ,A,B), where Tᵢ is the dependent variable, Rᵢ the independent variable, and A and B unknown regression parameters. In various embodiments, a regression function may be used to evaluate a relative temperature, T, from measured signal ratio, R.

### Calibration Measurements

In one example embodiment, the additive manufacturing apparatus of FIG. 7 can be installed on an EOS M290 laser powder bed fusion machine. The gains on both the high and low wavelength sensors can be set to ensure that the recorded signals are below the saturation voltage and above the noise floor during typical processing conditions. To ensure this, the gains may be set while the M290 is fabricating a square which spans the entire build plate. The gains can be set such that the higher of the two signals averages 75% of the saturation voltage across the build plate. At the end of the build, the laser may be commanded to go to the center of the build plate, so that the galvanometer mirrors are focused for calibration on a central source.

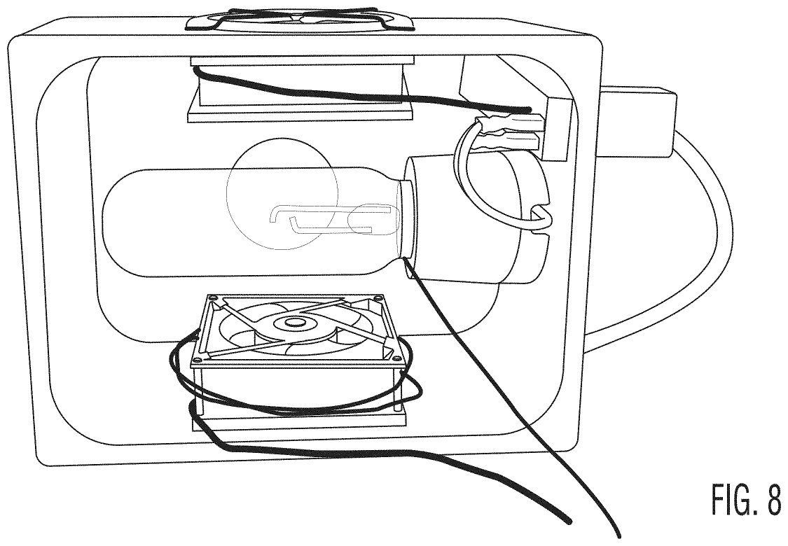

Next, the calibrated lamp may be positioned. The build plate can be lowered by 45 mm, such that the lamp's filament is positioned at the same height as the melt pool during processing. The lamp can be contained in the temperature calibration block such that it is horizontal and vertically aligned with the aperture on the top of the block. The high wavelength photodetector may be removed along with the optics tube, and may be replaced with a Thorlab s PL202 HeNe USD laser, for example, which can be used to illuminate the center of the build plate, and the calibration block is moved such that the lamp is centered on the build plate. After XY block alignment, the HeNe laser can be removed and the high wavelength photodetector and optical tube are returned. An image of the calibration setup is shown in FIG. 8.

Before the lamp is powered, measurements can be taken with the lights turned off inside the additive manufacturing apparatus of FIG. 7 and the room. A median value of each the high and low wavelength sensors with lights off can be measured to be their corresponding dark voltages. These voltages are subtracted from all measurements from the corresponding sensors, before they are used to calculate temperature. In some embodiments, the lamp may be current-controlled by a Rohde & Schwarz HMP4040 programmable DC power supply. Table 1 shows a representative temperature and current setpoints used for calibration, where the lamp had been calibrated by Pyrometry LLC using a NIST-traceable transfer pyrometer to achieve predetermined temperature setpoints.

TABLE 1

| Temperature (° C.) | 1300 | 1400 | 1500 | 1600 | 1700 | 1800 | 1900 | 2000 | 2100 | 2200 | 2300 |
|---|---|---|---|---|---|---|---|---|---|---|---|
| Current (A) | 7.08 | 7.61 | 8.21 | 8.9 | 9.64 | 10.44 | 1127 | 12.18 | 13.13 | 14.11 | 15.14 |

The temperature can be set to each setpoint and let to stabilize for 1 minute, starting from 1,300° C. A Hantek 1008C oscilloscope is used to monitor both of the sensor voltages to ensure that they remain within the acceptable range. The aperture can be set such that the higher sensor is reading 85% of its saturation voltage when the calibration source is set to 2,300° C., ensuring that the sensors will not saturate.

### Calibration Calculations

In some embodiments, both detector channels can be acquired synchronously, thus each element corresponds to measurement at the same point in time. For each temperature setpoint Tᵢ, the ratio,

$$\frac{{S}_{1} ( T )}{{S}_{2} ( T )} ,$$

is calculated by elementwise division of the time series high and low wavelength photodetector signals after dark current subtraction, Rᵢ(t)=S₁(t)/S₂(t). The median value of the time series ratio Rᵢ(t) is recorded for each temperature setpoint, and used to regress to values of A and B in equation 7, which follows from equation 6.

$${T}_{i} = \frac{A}{ln ( B / {R}_{i} )} \qquad ( 7 )$$

Within each 5 second data capture of Rᵢ(t), the standard deviation of the temporally middle 400 values was calculated, to identify trends in signal variation as a function of temperature. Assuming a constant random distribution of noise, \tilde{X}, in the otherwise constant sensor signals S₁(T) and S₂(T) at a constant temperature, the variance in the ratio

$$\frac{S ( {λ}_{1} , T ) + \tilde{X}}{S ( {λ}_{2} , T ) + \tilde{X}}$$

can increase with decreasing temperature, which decreases with sensor signal.

### Spatial Normalization Methodology

In some applications there are many effects which may change the ratio of high and low wavelength signals spatially over the build plate, including but not limited to:

1) Path length variation

2) Angle-dependent transmission through the optics

3) Spherical aberration

Variations can be described as a proportional change in transmission in each high and low wavelength separately, which varies as a function of position and not in time. In some embodiments, to quantify the proportional reduction in transmission, it can be assumed that temperature, and therefore the ratio of low/high wavelength signals, is a constant across the build plate.

Full build plates may be fabricated. Once the process has reached a steady state, four layers can be recorded. The raw data for the high and low signals from each of these layers is rastered into 50 micron resolution images. For each layer, the low wavelength signal image can be elementwise divided by the high wavelength signal image, to produce a single ratio signal image. The four ratio images can then be averaged. The averaged image can be normalized such that the average value in the center 2 mm by 2 mm square on the build plate is equal to one. This image contains all of the values used for correcting the incoming temperature data. For every raw temporal data, the nearest pixel in the correction value image was located, raw ratio data's value was divided by that correction value, producing a corrected ratio which was used to calculated spatially corrected temperature.

### Regression and Variation

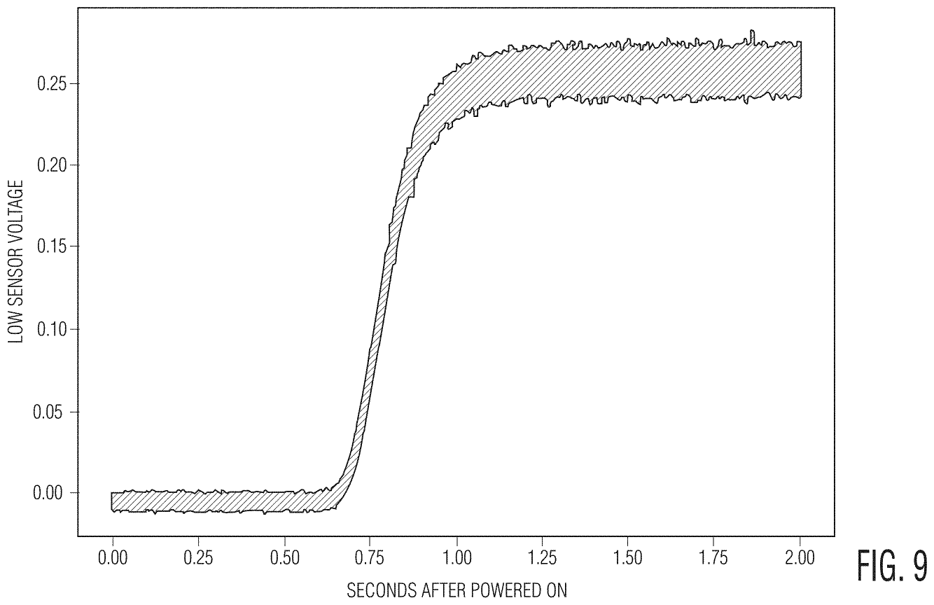

Prior to calibration, the lamp was powered on to 1,700° C. from room temperature. The signal from the low wavelength photodetector was measured over time as power was applied to the lamp, to determine the time to reach steady state temperature. The results of signal versus time is shown in FIG. 9, where low sensor voltage versus time is plotted when the lamp is powered on. As shown in FIG. 9, it was determined that steady state was achieved within 2 seconds. The one minute dwelltime for temperature to stabilize can adequately satisfy the dwelltime used. After this measurement is taken, the lamp can be powered off until it is no longer visibly emitting light before proceeding with the calibration.

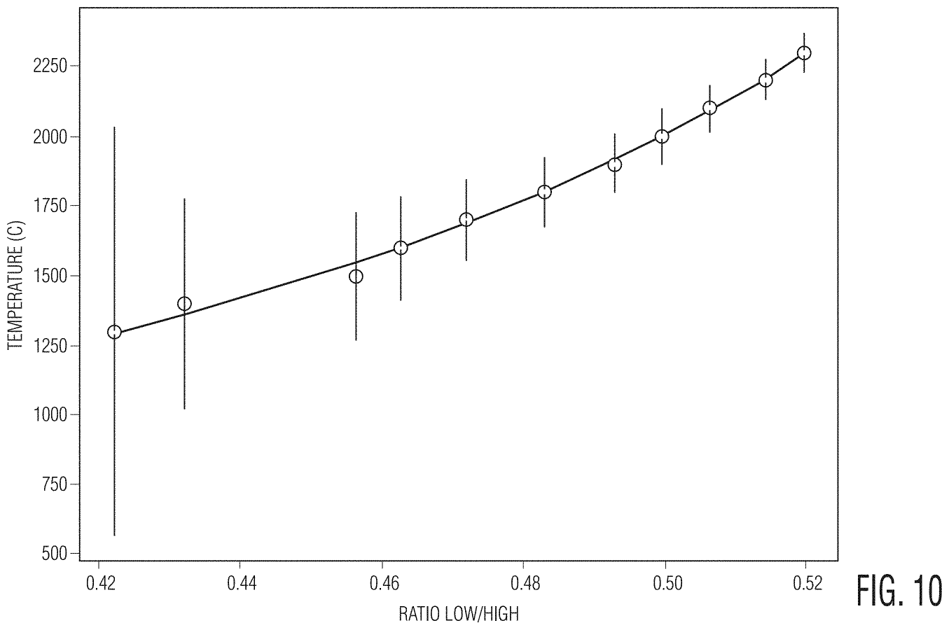

Regressing the median value of Rᵢ(t) (over the central 400 points) for each temperature against the setpoints yields an equation with A=618.75 and B=0.681, with an R² value of 0.996, as shown in FIG. 10. FIG. 10 shows setpoint temperature versus mean signal ratio (blue dots) with curve fit (blue line). Note that the error bars in FIG. 10 do not indicate prediction uncertainty, but the +/−1σ standard deviation of measured temperature using the regression model at a given setpoint.

The disclosed model can estimate the setpoints with an RMSE of 19.42° C. For each of the 400 temporally middle values of Rᵢ(t) at each temperature setpoint, the temperature T(t) was calculated based on the calibration regression model developed in equation 7. The standard deviation of these 400 temperature values was recorded, to quantify sensor noise, in terms of measured temperature. These standard deviations are shown in Table 2 and plotted as error bars in FIG. 10. A standard deviation of the data collected increases with decreasing temperature, as the temperature is calculated from a ratio of two signals which both contain noise. As the signals decrease with decreasing temperature, the noise makes up a larger portion of the ratio's variance. Measured temperature standard deviation as a function of temperature setpoint is shown in Table 2.

TABLE 2

| Setpoint (° C.) | 1300 | 1400 | 1500 | 1600 | 1700 | 1800 | 1900 | 2000 | 2100 | 2200 | 2300 |
|---|---|---|---|---|---|---|---|---|---|---|---|
| Standard Deviation (° C.) | 734 | 382 | 225 | 190 | 148 | 130 | 109 | 104 | 87.8 | 77.5 | 73.0 |
| Model Prediction (° C.) | 1295 | 1361 | 1547 | 1603 | 1688 | 1803 | 1915 | 1998 | 2090 | 2206 | 2290 |

It is noted that the standard deviation of the sampled data may not be a good metric of sensor uncertainty. Because anomalous signals span more than 1 temporal data sample (5 μs), the uncertainty of the sensor in additive manufacturing apparatus of FIG. 7 can be a function of the length of time that the signal is acquired. The equation to calculate standard error,

$$SE = \frac{σ}{\sqrt{n}} ,$$

can be rearranged to calculate the number of samples used to reduce the standard error below a defined threshold value of SE.

$$n = ceiling ( {( \frac{σ}{SE} )}^{2} ) \qquad ( 8 )$$

The results of applying this formula to various values can be found in Table 3. To achieve the same standard error as 1,900° C. but at other setpoint temperatures, the used sampling time roughly doubles at 1,700° C. and is roughly 60 times as high at 1,300° C.

TABLE 3

| | Setpoint (° C.) | | | | | | | | | | |
|---|---|---|---|---|---|---|---|---|---|---|---|
| Standard Error (° C.) | 1300 | 1400 | 1500 | 1600 | 1700 | 1800 | 1900 | 2000 | 2100 | 2200 | 2300 |
| 100 | 270 | 75 | 30 | 20 | 15 | 10 | 10 | 10 | 5 | 5 | 5 |
| 75 | 480 | 130 | 45 | 35 | 20 | 20 | 15 | 10 | 10 | 10 | 5 |
| 50 | 1080 | 295 | 105 | 75 | 45 | 35 | 25 | 25 | 20 | 15 | 15 |
| 25 | 4315 | 1170 | 405 | 290 | 180 | 140 | 100 | 90 | 65 | 50 | 45 |
| 10 | 26940 | 7300 | 2535 | 1805 | 1100 | 845 | 595 | 545 | 390 | 305 | 270 |

While the photodetectors may have inherent noise, the standard deviations are a function of the source size (e.g, calibration lamp or melt pool) as well as sensor gain settings. Thus, the standard deviation of a co-axial melt pool monitoring sensor's response may depend on multiple factors pertaining to the melt pool and region within the sensor's field of view. For example, changes in sensor signal standard deviation may stem from:

1) The surface area of the melt pool

2) Sensor gain/material processing window

3) Melt pool emissivity

4) Other incandescing sources, such as spatter or plume

For example, if a hypothetical melt pool was a uniform 1,300° C. and larger than the 2 mm by 8 mm tungsten filament of the calibration lamp, more photons may reach the sensor, resulting in a higher signal to noise ratio. The readings may have a smaller standard deviation of the data over time. The opposite would be true if the melt pool were smaller than the tungsten filament.

In some embodiments, when a different material is chosen for processing with a lower relative melt pool size or temperatures, higher gain values may be selected. The standard deviation of sensor data over time would be reduced, and measurements could be recorded at reduced temperatures. However, the maximum temperature detectable would also be reduced, as the sensor would be more prone to saturation. The opposite trend would be observed for reducing the sensor gain. Changes in melt pool emissivity would have a similar effect as changes in melt pool size. Everything else held constant, a reduction in melt pool emissivity can reduce the number of emitted photons. The sensors' signals can be reduced and the standard deviation of the temperature calculated will increase.

In various embodiments, the measured temperature's uncertainty a function of signal strength or melt pool/filament length can be demonstrated in measured results. The previous procedure is repeated, with the addition of a neutral density (ND) filter of optical density OD 1, used to attenuate the signal intensities. The tungsten lamp source's aperture can be set such that the higher of the two signals is 85% of its saturation voltage while the ND filter is placed above the aperture. In a separate measurement, the ND filter is measured to reduce the signal of the high photodiode to 13.71% of its unfiltered signal and the low photodiode to 10.57% of its unfiltered signal. These values can be used to normalize the signals measured when the ND filter is placed over the aperture, to account for imperfections in the filter. This measurement can be repeated with no ND filter over the aperture initially, in order to increase the signal intensities at lower temperatures.

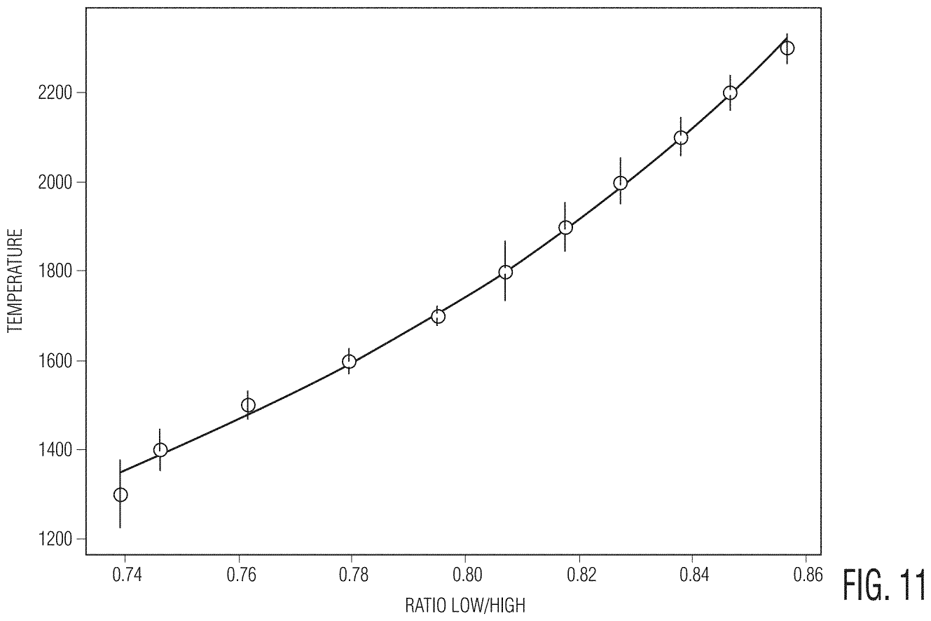

When a temperature is reached that indicates either signal is above 75% of the saturation voltage, the ND filter can be placed on the aperture for the remainder of the testing. Although the ND filter may affect the measured signal for both individual detectors, it does not affect the ratio of the signals, after accounting for the transmission percentages as described previously. It is expected that because relative sensor noise is higher whenever signal is lower, that the standard deviation of the measured temperature may decrease with increasing temperature, except for the temperature at which the ND filter is added. The results, regressing the median value of Rᵢ(t) (over the central 400 points) for each temperature setpoint is shown in FIG. 11. FIG. 11 shows setpoint temperature versus mean signal ratio (blue dots) with curve fit (blue line) for the ND test. In FIG. 11, the error bars do not indicate prediction uncertainty, but the +/−1σ standard deviation of measured temperature using the regression model at a given setpoint.

In some embodiments, the ND filter can be added at the 1800° C. setpoint. The model fits to this data with an R² value of 0.996, A=447.52 and B=1.0523. The model estimates the setpoints with an RMSE of 19.70° C. The standard deviations of this model are overall lower, particularly at lower temperatures, and there is an increase in deviation at the datapoint which the ND filter was added. The model can predict temperature with a standard deviation which is 1.3-6.1% of the setpoint temperature. The predictions of the regression model and standard deviations of the temperature predictions can be found in Table 4.

TABLE 4

| Setpoint (° C.) | 1300 | 1400 | 1500 | 1600 | 1700 | 1800 | 1900 | 2000 | 2100 | 2200 | 2300 |
|---|---|---|---|---|---|---|---|---|---|---|---|
| Standard Deviation (° C.) | 79.7 | 49.2 | 34.4 | 29.0 | 22.7 | 69.0 | 58.3 | 52.7 | 44.4 | 40.0 | 34.6 |
| Model Prediction (° C.) | 1352 | 1389 | 1477 | 1591 | 1703 | 1800 | 1891 | 1984 | 2095 | 2195 | 2321 |

In a similar construction as the previous dataset, the sampling time used to produce a sample with a given standard error was calculated for this dataset, shown in Table 5. It should be noted that neither the standard deviations nor durations for a standard error for this dataset or the prior dataset are characteristic of the standard deviations and sampling periods during additive manufacturing processing. There are other inputs which may affect these values.

TABLE 5

| | Setpoint (° C.) | | | | | | | | | | |
|---|---|---|---|---|---|---|---|---|---|---|---|
| Standard Error (° C.) | 1300 | 1400 | 1500 | 1600 | 1700 | 1800 | 1900 | 2000 | 2100 | 2200 | 2300 |
| 100 | 5 | 5 | 5 | 5 | 5 | 5 | 5 | 5 | 5 | 5 | 5 |
| 75 | 10 | 5 | 5 | 5 | 5 | 5 | 5 | 5 | 5 | 5 | 5 |
| 50 | 15 | 5 | 5 | 5 | 5 | 10 | 10 | 10 | 5 | 5 | 5 |
| 25 | 55 | 20 | 10 | 10 | 5 | 40 | 30 | 25 | 20 | 15 | 10 |
| 10 | 320 | 125 | 60 | 45 | 30 | 240 | 175 | 140 | 100 | 80 | 60 |

### Spatial Normalization

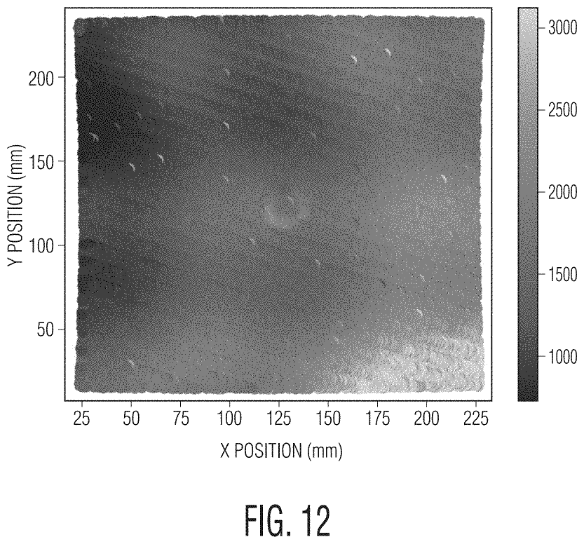

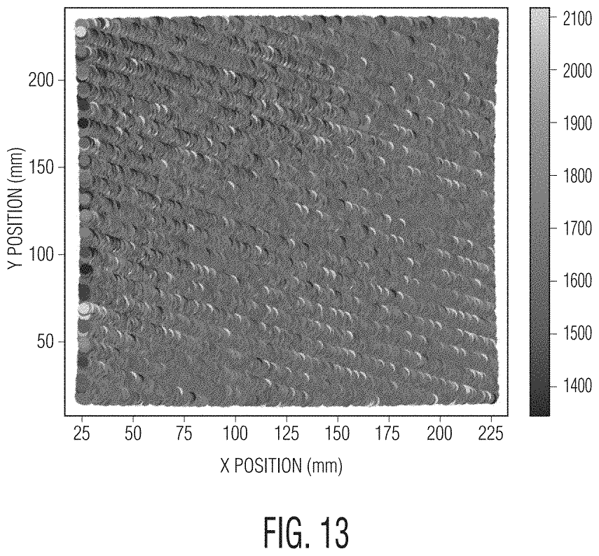

In various embodiments, for a full build plate measurements, the data can be sampled at 200 kHz, and the calibration formula can be applied to each individual data point to predict a temperature for that location. A scatterplot of the temperature values from a full build plate build is shown in FIG. 12. As described previously, for every data point the ratio of the signals can be divided by the spatially nearest correction value, which can be used to calculate an adjusted temperature. A scatterplot of the corrected temperatures is found in FIG. 13.

It can be seen in FIG. 13 that the disclosed calibration method can reduce the spatial variations in the original data. A standard deviation of temperatures in the non-corrected dataset is 109° C. In the calibrated dataset in FIG. 13, the standard deviation is 32.8° C. This method may make an assumption that the temperature may not vary as a function of position on the build plate. With this assumption, real position-dependent process effects may be masked. In some embodiments, a method is used to improve the optical hardware, such that position-dependent optical transmission can be reduced, using knowledge of the source of the position-variation pattern.

The presence of patterns can be attributed to optical interference patterns produced by the partially coherent light emanating from the melt pool/plume combination. The source of the light is related to that of the laser which provides the power to melt the powder bed. The infrared radiation may be transformed in and near the melt pool by various processes into visible radiation which propagates back through the optical system of the printer. In some embodiments, a procedure for transformation of high power, focused, near infrared radiation proceeds as follows: A melt pool can be established by the focused radiation having considerable vapor pressure of the printed alloy constituents. These metal vapor atomic species are partially ionized through the photoelectric effect driven by the focused laser's high electric field. The electrons and metallic ions can be accelerated by the laser's electric field and collisionally excite the neutrals to states above that established by the thermally induced Boltzmann distribution characteristic of the somewhat superheated melt pool.

These excited states due to collisional excitation may have a high probability of radiation with lifetimes in nanosecond range. A competing process, de-excitation by collisions with cooler species can have a lower probability as the system density is low. Thermally excited Boltzmann distribution of metal quantum states may contribute background radiation of a lesser amount at the wavelengths characteristic of the respective materials. In various embodiments, a method for the non-linear optical production of harmonics of the near infrared high power melt-laser with the metal vapor components acting as the nonlinear optical medium is disclosed. Due to existence of nonlinear, non-equilibrium conditions, an emerging light spectrum (visible in the spectroscopy of the plume) may have partial coherence driven by the melt-laser, which may cause interference patterns. In some embodiments, this can be eliminated by depolarizing the light entering the optical train.

In various embodiments, methods of calibration may include measuring at different laser angles, or at different locations on the build plane, or calibrating/testing when the optics heat up during additive manufacturing processing.

Embodiments of the present disclosure provide apparatus and methods for Bichromatic Planck thermometry and a regression framework for Bichromatic Planck thermometry calibration. In some embodiments, using a tungsten lamp as a blackbody source, the regression framework is validated. In the example setup described above, the gain values used for calibration may vary by machine to account for any variation. This will allow for sensors from different machines to yield the same calibrated readings. As a result of this methodology, a temperature calibration with an accuracy of 1.3-6.1% can be realized using Bichromatic Planck Thermometry. In addition, trends in data variation as a function of temperature can be analyzed, showing that with a constant sensor gain, the standard deviation of sensor readings decreases with increasing temperature. In various embodiments, it is shown that this change in the standard deviation of predicted temperatures is not solely due to the source temperature, but also due to the amount of signal being reduced at lower source temperatures. In some embodiments, low standard deviation readings can be achieved at lower temperatures by increasing signal. In various embodiments, a method is disclosed for reducing spatial deviations in temperature measured.

One of skill in the art with the benefit of this disclosure will appreciate that the disclosed systems and methods of calibration are not limited to laser based additive manufacturing processes. Other additive manufacturing processes can employ similar techniques to improve calibration of monitoring sensors including, but not limited to electron beam-based systems and UV curing-based systems.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

What is claimed is:

1. A method of calibration in an additive manufacturing system, the method comprising:
measuring an amount of energy radiated from a black body source at a first wavelength;
measuring an amount of energy radiated from the blackbody source at a second wavelength, the second wavelength being spaced apart from the first wavelength; and
generating a relationship between a ratio of the amount of energy radiated at the first wavelength to the amount of energy radiated at the second wavelength.

2. The method of claim 1, wherein the measuring an amount of energy radiated from the black body source at the first wavelength is performed by a first photo detector, and the measuring an amount of energy radiated from the black body source at the second wavelength is performed by a second photo detector.

3. The method of claim 2, wherein the measuring an amount of energy radiated from the black body source at the first wavelength comprises collecting first voltages generated by the first photo detector in response to receiving the radiated energy from the black body source.

4. The method of claim 3, wherein the measuring an amount of energy radiated from the black body source at the second wavelength comprises collecting second voltages generated by the second photo detector in response to receiving the radiated energy from the black body source.

5. The method of claim 4, wherein generating the relationship comprises generating a ratio of first voltages to second voltages.

6. The method of claim 1, wherein the black body source is positioned where a melt pool on a build plane of an additive manufacturing system would be during an operation of the additive manufacturing system.

7. The method of claim 1, wherein the black body source comprises a halogen lamp.

8. The method of claim 1, further comprising determining, using the relationship, variations in a temperature of a build plane of an additive manufacturing system based upon a ratio of energy radiated at the first wavelength to energy radiated at the second wavelength.

9. The method of claim 5, further comprising determining a temperature of a melt pool on a build plane of an additive manufacturing system by measuring amounts of energy radiated by the melt pool at the first and second wavelengths, and using the ratio of the first voltages to the second voltages to determine the temperature of melt pool.

10. A calibration apparatus comprising:
first and second optical sensors arranged to record an intensity of radiation emitted from a build region of an additive manufacturing system at a first bandwidth and a second bandwidth, respectively;
a black body source;
a processor; and
a memory coupled to the processor and comprising instructions executable by the processor, the instructions directing the processor to:
collect measured amount of energy, by the first optical sensor, radiated from the black body source at the first bandwidth;
collect measured amount of energy, by the second optical sensor, radiated from the black body source at the second bandwidth; and
generate a calibration relationship based on a ratio of the collected measured amount of energy radiated at the first bandwidth to the collected measured amount of energy radiated at the second bandwidth.

11. The calibration apparatus of claim 10, wherein the first and second optical sensors are first and second photo detectors, respectively.

12. The calibration apparatus of claim 11, wherein generating the calibration relationship comprises generating a ratio of first generated voltages by the first photo detector for known black body source temperatures to second generated voltages by the second photo detector for known black body source temperatures.

13. The calibration apparatus of claim 12, wherein the black body source is positioned where the build region on a build plane of the additive manufacturing system would be during an operation of the additive manufacturing system.

14. The calibration apparatus of claim 13, wherein the black body source comprises a tungsten strip lamp.

15. The calibration apparatus of claim 10, wherein the instructions direct the processor further to determine variations in a temperature of a build plane of the additive manufacturing system based upon a ratio of an amount of energy radiated at the first bandwidth to an amount of energy radiated at the second bandwidth.

16. The calibration apparatus of claim 12, wherein the instructions direct the processor further to determine a temperature of the build region of the additive manufacturing system based on a ratio of an amount of energy radiated by the build region at the first bandwidth to an amount of energy radiated at the second bandwidth during an operation of the additive manufacturing system by using the calibration relationship.

17. A method of calibration, the method comprising:
generating first voltages, by a first photo detector, in response to receiving an amount of energy radiated from a blackbody source at a first wavelength, the black body source being at a known temperature;
generating second voltages, by a second photo detector, in response to receiving an amount of energy radiated from a blackbody source ata second wavelength, the blackbody source being at the known temperature; and
generating a calibration relationship based on a ratio of the first voltages to the second voltages.

18. The method of claim 17, further comprising determining, using the calibration relationship, variations in a temperature of a build plane of an additive manufacturing system based upon a ratio of energy radiated at the first wavelength to energy radiated at the second wavelength.

19. The method of claim 17, wherein the black body source comprises a halogen lamp.

20. The method of claim 17, wherein the black body source is positioned where a molten region on a build plane of an additive manufacturing system would be during an operation of the additive manufacturing system.
